(19) United States
(12) Patent Application Publication
(10) Pub. No.: US 2020/0267755 A1
(43) Pub. Date: Aug. 20, 2020

(54) Multiple Semi-Static Grant Activation And Deactivation By Single DCI In Mobile Communications

(71) Applicant: MediaTek Inc., Hsinchu City (TW)

(72) Inventors: Ahmet Umut Ugurlu, Cambridge (GB); Ju-Ya Chen, Hsinchu City (TW)

(21) Appl. No.: 16/789,426

(22) Filed: Feb. 13, 2020

Related U.S. Application Data
(60) Provisional application No. 62/806,014, filed on Feb. 15, 2019.

(51) Int. Cl. H04W 72/14; H04W 72/04

(52) U.S. Cl. CPC H04W 72/14; H04W 72/0453

(57) ABSTRACT

Various examples and schemes pertaining to multiple semi-static grant activation and deactivation by a single downlink control information (DCI) transmission in mobile communications are described. An apparatus receives, from a wireless network, a dynamic signaling. The apparatus then activates or deactivates, according to the dynamic signaling, one or more grant configurations associated with one or more configured grants of a plurality of configured grants related to transmissions or receptions with respect to the apparatus.

### CROSS REFERENCE TO RELATED PATENT APPLICATION(S)

The present disclosure is part of a non-provisional application claiming the priority benefit of U.S. Patent Application No. 62/806,014, filed on 15 Feb. 2019, the content of which being incorporated by reference in its entirety.

### TECHNICAL FIELD

The present disclosure is generally related to wireless communications and, more particularly, to techniques pertaining to multiple semi-static grant activation and deactivation by a single downlink control information (DCI) transmission in mobile communications.

### BACKGROUND

Unless otherwise indicated herein, approaches described in this section are not prior art to the claims listed below and are not admitted as prior art by inclusion in this section.

In Long-Term Evolution (LTE), the Uu interface supports multiple semi-persistent scheduling (SPS) configurations in uplink (UL) transmissions. Activation of an SPS configuration is signaled in DCI. The SPS configuration identification (ID) can be indicated either in a dedicated SPS configuration index field or in the hybrid automatic repeat request (HARQ) process number field. Thus, in LTE, a single DCI can activate only one SPS configuration at a time. In New Radio (NR), the Uu interface supports Type-1 and Type-2 UL grant-free configurations. It has been agreed in the 3^{rd} Generation Partnership Project (3GPP) that Type-2 grant-free supports multiple active configurations per bandwidth part (BWP). As NR vehicle-to-everything (V2X) supports both aperiodic and periodic traffic with more strict latency and reliability requirements, there is a need for a solution that supports simultaneous activation and release (herein interchangeably referred to as “deactivation”) of multiple Type-2 grant-free configurations by a single DCI.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure aims to propose concepts, solutions, schemes, techniques, designs, methods and apparatus pertaining to multiple semi-static grant activation and deactivation by a single DCI transmission in mobile communications.

In one aspect, a method may involve a processor of an apparatus receiving, from a wireless network, a dynamic signaling. The method may also involve the processor activating or deactivating, according to the dynamic signaling, one or more grant configurations associated with one or more configured grants of a plurality of configured grants related to transmissions or receptions with respect to the apparatus.

In one aspect, a method may involve a processor of an apparatus receiving, from a wireless network, a dynamic signaling. The method may also involve the processor activating or deactivating, according to the dynamic signaling, a plurality of grant configurations associated with a plurality of configured grants related to transmissions or receptions with respect to the apparatus.

It is noteworthy that, although description provided herein may be in the context of certain radio access technologies, networks and network topologies such as 5th Generation (5G) and NR V2X, the proposed concepts, schemes and any variation(s)/derivative(s) thereof may be implemented in, for and by other types of radio access technologies, networks and network topologies such as, for example and without limitation, LTE, LTE-Advanced, LTE-Advanced Pro and any future-developed networks and technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure may be implemented.

FIG. 3 is a diagram of an example scenario in accordance with an implementation of the present disclosure may be implemented.

FIG. 4 is a diagram of an example scenario in accordance with an implementation of the present disclosure may be implemented.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to semi-static grant activation and deactivation by a single DCI transmission in mobile communications. According to the present disclosure, a number of possible solutions may be implemented separately or jointly. That is, although these possible solutions may be described below separately, two or more of these possible solutions may be implemented in one combination or another.

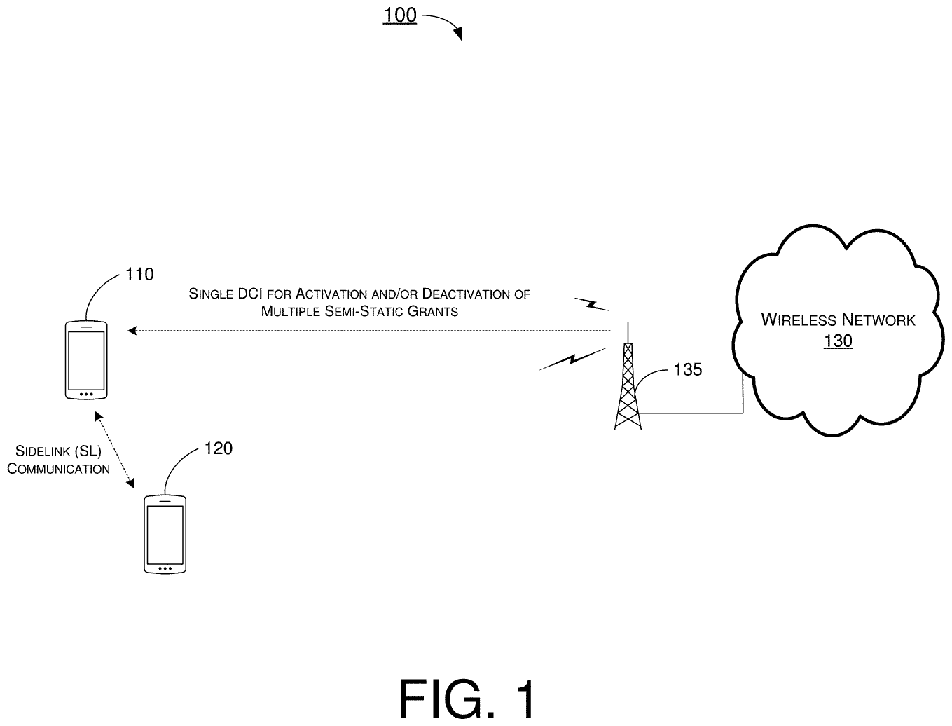

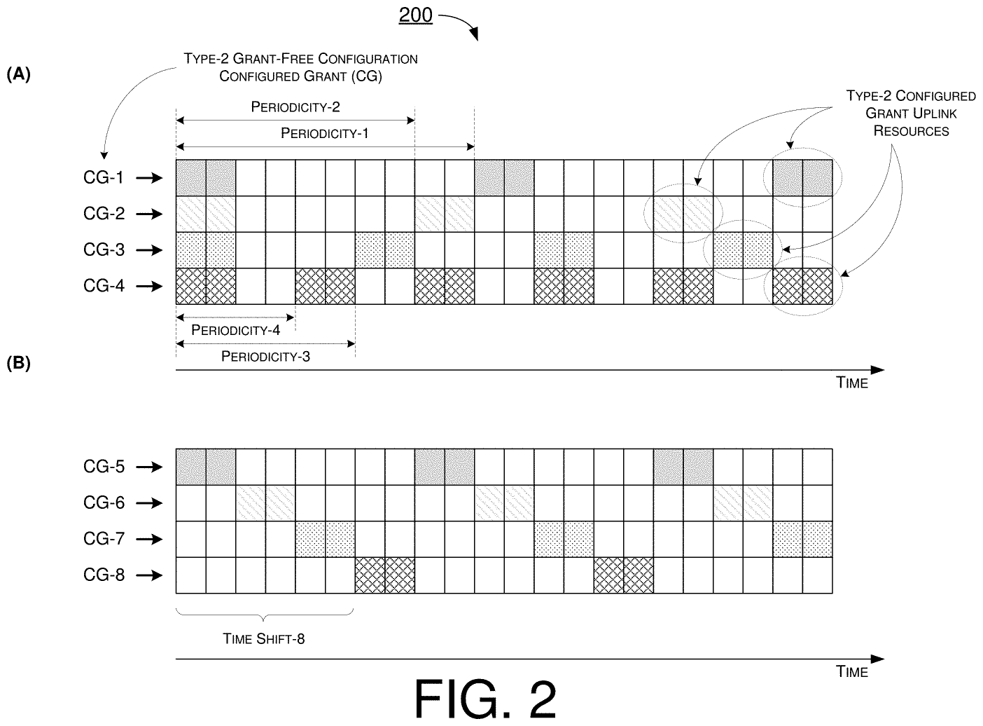

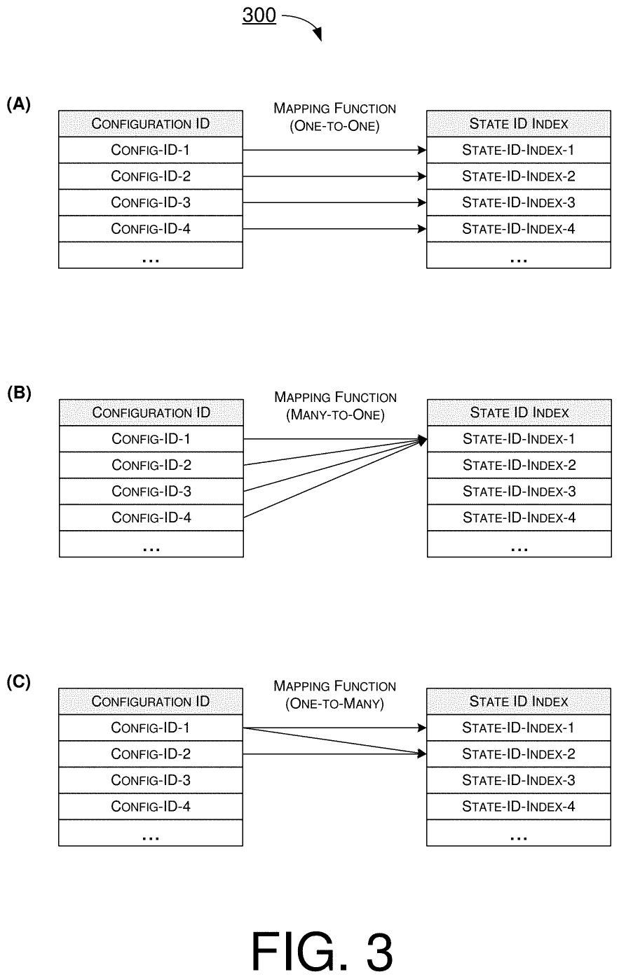

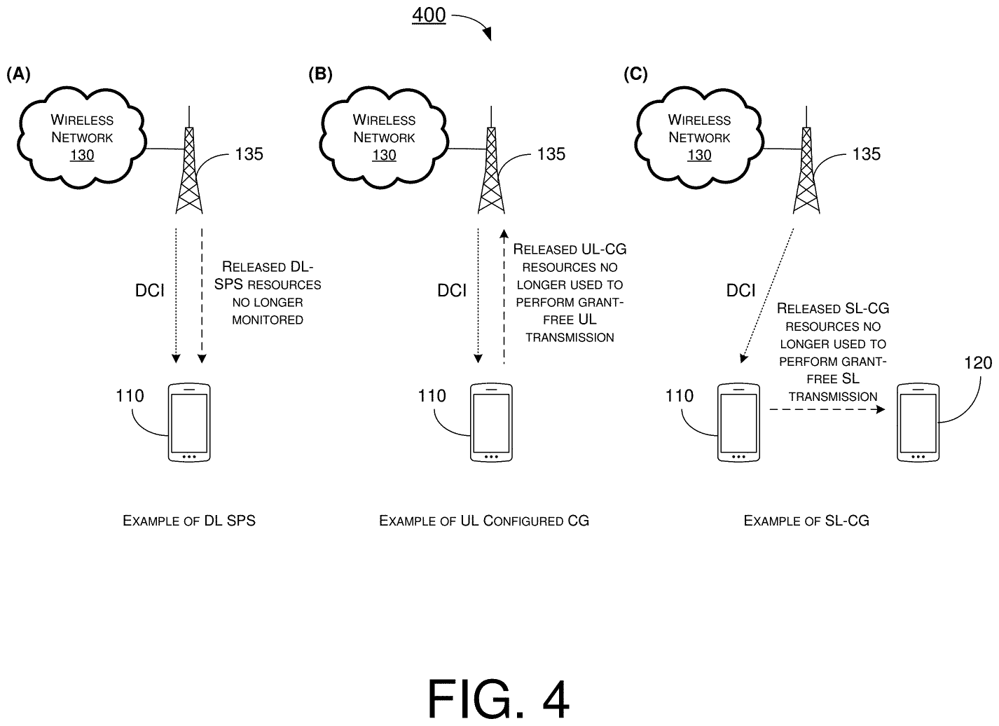

FIG. 1 illustrates an example network environment 100 in which various solutions and schemes in accordance with the present disclosure may be implemented. FIG. 2, FIG. 3 and FIG. 4 illustrate example scenarios 200, 300 and 400 in which various implementation in accordance with the present disclosure may be implemented. Each of scenario 200, scenario 300 and scenario 400 may be implemented in network environment 100.

Referring to FIG. 1, network environment 100 may be an NR communication (e.g., NR V2X communication) environment involving a user equipment (UE) 110, another UE 120, and a wireless network 130 (e.g., an NR mobile network). Each of UE 110 and UE 120 may be in wireless communication with one another via an NR sidelink (SL) communication. Wireless network 130 may be in wireless communication with either or both of UE 110 and UE 120 via a base station or a network node 135 (e.g., an eNB, gNB or transmit/receive point (TRP)). Each of UE 110 and UE 120 may be in or as a part of, for example and without limitation, a portable apparatus (e.g., smartphone), a vehicle or a component thereof, a roadside unit (RSU) (e.g., a traffic signal, a streetlamp, a roadside sensor or a roadside structure) or an Internet of Thing (IoT) device (e.g., a sensor). In network environment 100, UE 110, UE 120 and wireless network 130 (via base station 135) may implement various schemes pertaining to semi-static grant activation and deactivation by a single DCI transmission in mobile communications in accordance with the present disclosure, as described below. It is noteworthy that, although FIG. 1 shows UE 110 in communication with UE 120 via an NR sidelink, in various scenarios UE 110 may be simultaneously in communication with more than one UEs via NR sidelinks while implementing one or more proposed schemes in accordance with the present disclosure.

Referring to FIG. 2, scenario 200 illustrates multiple Type-2 grant-free configurations of configured grants (CGs) at UE 110. As shown in part (A) of FIG. 2, UL resources for configurations 1, 2, 3 and 4 (denoted as “CG-1”, “CG-2”, “CG-3” and “CG-4” in FIG. 2, respectively) may start from the same time instance and may support different periodicities. As shown in part (B) of FIG. 2, UL resources for configurations 5, 6, 7 and 8 (denoted as “CG-5”, “CG-6”, “CG-7” and “CG-8” in FIG. 2, respectively) may have the same periodicity but may support different time shifts or offset values.

In scenario 200, in case that UE 110 is expected to send aperiodic UL traffic with strict latency requirements, it may be desirable to activate multiple configured grants with different time shifts/offsets and similar periodicities (e.g., configurations 5 and 7). Moreover, in case that UE 110 is expected to send aperiodic traffic with even more strict latency requirements, all four configurations 5, 6, 7 and 8 may need to be activated at UE 110. Moreover, in case that UE 110 is expected to have periodic UL traffic, UE 110 may first send an assistance information report to wireless network 130 to indicate the expected transmission periodicity of its traffic. Then, wireless network 130 may activate multiple configured grants with different resource periodicities similar to the reported expected periodicity. Alternatively, multiple configured grants with the same periodicity but different time/frequency resources may need to be activated. For NR periodic traffic, the period may be constant while packet size may be alternating between several known sizes. Moreover, the period of the traffic itself may not be constant for the same service type.

In view of aforementioned reasons, wireless network 130 may activate or deactivate (or release) multiple configured grants simultaneously based on expected traffic pattern characteristics. The periodicity and message size in LTE-V2X traffic are often constant and predictable, as the main functionality and service is to deliver basic safety cooperative awareness messages (CAMs) and decentralized environmental notification messages (DENMs). In contrast, NR-V2X supports more advanced use cases where a lot of variations may be expected in traffic patterns.

Thus, under a proposed scheme in accordance with the present disclosure, a single DCI may be used to activate or deactivate multiple configurations simultaneously. Advantageously, doing so may result in a number of benefits including, for example and without limitation, better resource utilization, lower Layer 1 (L1) activation/deactivation signaling overhead, and faster configured grant activation/deactivation leading to improved latency performance. Nevertheless, there are some design challenges that need to be addressed to support single DCI activation/deactivation of multiple configured grants.

One challenge is the indication of multiple configuration IDs in a single activation on DCI, which may result in dynamically varying DCI payload size. Specifically, indicating different numbers of configured grants may require varying DCI payload size. Separate modulation and coding schemes (MCSs) and time/frequency resource allocation fields (e.g., multiple transmission parameter sets) may need to be defined in DCI in addition to different CG configuration IDs. However, a new DCI format is not desirable. It is not clear how to inform UE 110 about the DCI size for decoding and/or parsing. Another issue is the incrementally increased DCI overhead with activation/deactivation of more configurations. For example, more payload size would be required when a single DCI is used to activate three configured grants as compared to the payload size of another DCI that is used to activate two configured grants.

Another challenge is the limited flexibility with group activation. One possibility is to treat multiple configurations as one configuration set or one configuration group. That is, most parameters may be common among all configurations that belong to the same configured grant configuration group. Moreover, all parameters that belong to different configured grant configuration groups may be separately configured with different parameters to accommodate different service/traffic types. However, such approach has limited flexibility as MCS/BWP carrier indicator fields need to be shared. Also, the number of configured grants or the number of supported serving cells may change in future NR releases which would require a new DCI format to accommodate different configuration groups.

An additional challenge is that using either common or separated parameters for multiple configurations does not offer flexible design. Two use cases can be considered for multiple grant-free configurations. In one case, different services can be supported with different reliability and latency requirements. In this case, MCS and transmission periodicity should be configured independently. Another case relates to sporadic traffic with low latency requirement. For this case some parameters (e.g., MCS) should be the same whereas different time resource positions with respect to a common time reference (e.g., time shift/offset) and maybe different frequency resources can be used to improve design flexibility in preventing collisions. A flexible design that allows both common and separated parameters for multiple configurations based on gNB implementation is preferred. In other words, in some scenarios, it is preferable to use common parameters among multiple configurations whereas separated parameters are preferred in some other cases.

In view of the above, the various proposed schemes in accordance with the present disclosure aim to support single DCI activation/deactivation of multiple configured grants while addressing aforementioned issues. Under one proposed scheme in accordance with the present disclosure, an additional higher-layer parameter may be introduced to support activation/deactivation of multiple configurations as a generalization of the activation/release design under Release 15 (Rel-15) of the 3GPP specification. Under the proposed schemes, a mapping parameter (or table) may be utilized to indicate either single or multiple configured grants during activation/deactivation. In that regard, different examples are illustrated in FIG. 3.

Referring to part (A) of FIG. 3, under one proposed scheme, the same Rel-15 functionality may be supported in an event that the mapping parameter/table defines a one-to-one match or correlation between a configuration ID and an state identification index. That is, only one configuration may be activated/deactivated at a time by a single DCI.

Referring to part (B) of FIG. 3, under one proposed scheme, in an event that the mapping parameter/table defines a many-to-one match or correlation between multiple configuration IDs and a state identification index, multiple configured grant configurations may be activated/deactivated simultaneously in a single DCI by the same state identification index. All configurations may share the same transmission parameters (e.g., MCS, time-domain resource allocation (TDRA), frequency-domain resource allocation (FDRA), carrier index, and so forth). In the example shown in part (B) of FIG. 3, all three configured grants associated with Config-ID-1, Config-ID-2 and Config-ID-3 may be activated together in a single DCI by State-ID-Index-1.

Referring to part (C) of FIG. 3, under one proposed scheme, in an event that the mapping parameter/table defines a one-to-many match or correlation between a configuration ID and multiple activation indices, a configured grant configuration may be activated/deactivated either alone or together with one or more other configurations. Under the proposed scheme, in case that the same configuration is activated multiple times by different activation indices, the latest activation signal (e.g., DCI in case of Type-2 configuration) may determine the transmission parameters (e.g., MCS). In the example shown in part (C) of FIG. 3, the configured grant associated with Config-ID-1 may be activated alone by State-ID-Index-1 or, alternatively, it may be activated simultaneously with Config-ID-2 via the same DCI by State-ID-Index-2.

Accordingly, the proposed schemes allow activation/deactivation of multiple configurations by a single instance or transmission of DCI without introducing any design restriction. The same Rel-15 activation/deactivation may be supported by configuring one-to-one mapping between one or more configuration indices and one or more activation indices. It is noteworthy that the term “activation ID” may refer to a unique integer value (e.g., binary or decimal or else) or a dedicated/unique radio network temporary identifier (RNTI) value. For instance, an activation DCI with cyclic redundancy check (CRC) scrambled with a specific RNTI may indicate a certain activation set (e.g., one or more grant-free configurations). The implementation details of the proposed schemes may be designed by use of a mapping parameter (e.g., a list/array of activation IDs) for each grant-free configuration. Alternatively, or additionally, the implementation details of the proposed schemes may be designed by use of a single mapping table for all grant-free configurations. Alternatively, or additionally, the implementation details of the proposed schemes may be designed by use of unique mapping IDs, each of which being assigned to a single pair of configuration ID and its corresponding state identification index.

As an illustrative and example implementation of a higher-layer parameter of mapping ID array/list per configuration, a new activation ID mapping field may be introduced in a ConfiguredGrantConfig information element (IE) in a RRC_Connection_Reconfiguration message. When one of the ID values in this mapping field is indicated in the activation/deactivation signal (e.g., DCI or radio resource control (RRC)), the corresponding grant-free configuration may be activated or deactivated. The DCI indication may use an existing field (e.g., HARQ process number field) or a new field having one or more bits.

As another illustrative and example implementation of a higher-layer parameter of a single mapping table for multiple configurations, a new activation ID mapping table may be introduced in the ConfiguredGrantConfig IE in the RRC_Connection_Reconfiguration message. When one of the activation IDs from the mapping table is indicated in the activation/deactivation signal (e.g., DCI or RRC), the corresponding grant-free configuration may be activated or deactivated.

It is noteworthy that any of the proposed schemes on multiple grant-free configurations may be applied to UL transmission configurations and/or sidelink (SL) V2X mode-1/mode-3 transmission configurations. Sidelink mode-1 transmission in NR V2X and sidelink mode-3 transmission in LTE V2X are configured by base station (e.g., base station 135). It is possible for UE 110 to be configured with multiple mode-1 SPS configurations in LTE and multiple Type-1 and/or Type-2 configurations in NR. It is also possible for UL configured grant(s) and a SL configured grant(s) to be simultaneously activated or deactivated in a single DCI. In such cases, any of the proposed schemes may be applied to multiple configurations which may include a mix of UL and SL grant-free (or SPS) configurations.

It is also noteworthy that any of the proposed schemes may be applicable to UL Type-1 grant-free configurations as well as UL Type-2 grant-free configurations. In case that multiple activate downlink (DL) SPS configurations are supported, the proposed schemes of activation/deactivation may be applied for DL SPS configurations as well.

It is further noteworthy that, for all the proposed schemes, there may be two possible interpretations, namely an “add to active list” interpretation and a “new active list” interpretation. With respect to the “add to active list” interpretation, previously activated configured grant(s) may stay active when a new activation signal is received. With respect to the “new active list” interpretation, previously activated configured grant(s) may be deactivated or otherwise released when a new activation signal is received.

For illustrative purposes and without limiting the scope of the present disclosure, illustrated in FIG. 4 are examples of DCI release (or deactivation) signaling and UE behavior upon release (or deactivation) of multiple configurations via a single DCI transmission.

The example shown in part (A) of FIG. 4 pertains to DL semi-persistent scheduling (SPS). Referring to part (A) of FIG. 4, UE 110 receives from network node 135 a transmission of DCI which indicates a state identifier. Accordingly, UE 110 releases multiple DL-SPS configurations associated with the indicated state identifier. As a result, UE 110 stops monitoring DL resources associated with the released DL-SPS configurations.

The example shown in part (B) of FIG. 4 pertains to UL configured grant (CG). Referring to part (B) of FIG. 4, UE 110 receives from network node 135 a transmission of DCI which indicates a state identifier. Accordingly, UE 110 releases multiple UL-CG configurations associated with the indicated state identifier. As a result, UE 110 is no longer allowed to perform transmission using UL resources associated with the released UL-CG configurations.

The example shown in part (C) of FIG. 4 pertains to SL Mode-1 CG (SL-CG). Referring to part (C) of FIG. 4, UE 110 receives from network node 135 a transmission of DCI which indicates a state identifier. Accordingly, UE 110 releases multiple SL-CG configurations associated with the indicated state identifier. As a result, UE 110 is no longer allowed to perform transmission using SL resources associated with the released SL-CG configurations. Illustrative Implementations

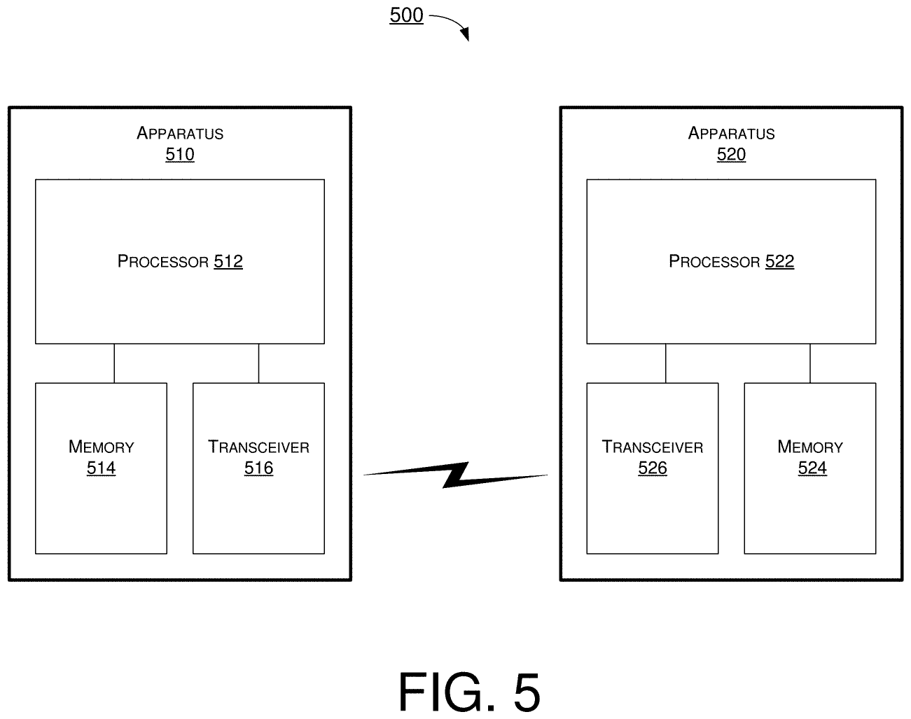

FIG. 5 illustrates an example communication system 500 having an example apparatus 510 and an example apparatus 520 in accordance with an implementation of the present disclosure. Each of apparatus 510 and apparatus 520 may perform various functions to implement schemes, techniques, processes and methods described herein pertaining to semi-static grant activation and deactivation by a single DCI transmission in mobile communications, including various schemes described above as well as processes described below.

Each of apparatus 510 and apparatus 520 may be a part of an electronic apparatus, which may be a UE such as a vehicle, a portable or mobile apparatus, a wearable apparatus, a wireless communication apparatus or a computing apparatus. For instance, each of apparatus 510 and apparatus 520 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an IoT or NB-IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. Alternatively, each of apparatus 510 and apparatus 520 may be implemented in the form of one or more integrated-circuit (IC) chips such as, for example and without limitation, one or more single-core processors, one or more multi-core processors, one or more multi-core processors, one or more reduced-instruction set computing (RISC) processors, or one or more complex-instruction-set-computing (CISC) processors. Each of apparatus 510 and apparatus 520 may include at least some of those components shown in FIG. 5 such as a processor 512 and a processor 522, respectively. Each of apparatus 510 and apparatus 520 may further include one or more other components not pertinent to the proposed scheme of the present disclosure (e.g., internal power supply, display device and/or user interface device), and, thus, such component(s) of each of apparatus 510 and apparatus 520 are neither shown in FIG. 5 nor described below in the interest of simplicity and brevity.

In some implementations, at least one of apparatus 510 and apparatus 520 may be a part of an electronic apparatus, which may be a vehicle, a roadside unit (RSU), network node or base station (e.g., eNB, gNB or TRP), a small cell, a router or a gateway. For instance, at least one of apparatus 510 and apparatus 520 may be implemented in a vehicle in a vehicle-to-vehicle (V2V) or V2X network, an eNodeB in an LTE, LTE-Advanced or LTE-Advanced Pro network or in a gNB in a 5G, NR, IoT or NB-IoT network. Alternatively, at least one of apparatus 510 and apparatus 520 may be implemented in the form of one or more IC chips such as, for example and without limitation, one or more single-core processors, one or more multi-core processors, or one or more RISC or CISC processors.

In one aspect, each of processor 512 and processor 522 may be implemented in the form of one or more single-core processors, one or more multi-core processors, or one or more RISC or CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including semi-static grant activation and deactivation by a single DCI transmission in mobile communications in accordance with various implementations of the present disclosure.

In some implementations, apparatus 510 may also include a transceiver 516, as a communication device, coupled to processor 512 and capable of wirelessly transmitting and receiving data. In some implementations, apparatus 510 may further include a memory 514 coupled to processor 512 and capable of being accessed by processor 512 and storing data therein. In some implementations, apparatus 520 may also include a transceiver 526, as a communication device, coupled to processor 522 and capable of wirelessly transmitting and receiving data. In some implementations, apparatus 520 may further include a memory 524 coupled to processor 522 and capable of being accessed by processor 522 and storing data therein. Accordingly, apparatus 510 and apparatus 520 may wirelessly communicate with each other via transceiver 516 and transceiver 526, respectively.

To aid better understanding, the following description of the operations, functionalities and capabilities of each of apparatus 510 and apparatus 520 is provided in the context of an NR communication environment in which apparatus 510 is implemented in or as a wireless communication device, a communication apparatus or a UE (e.g., UE 110) and apparatus 520 is implemented in or as a base station or network node (e.g., base station or network node 135) in network environment 100.

In one aspect of semi-static grant activation and deactivation by a single DCI transmission in mobile communications in accordance with the present disclosure, processor 512 of apparatus 510 may receive, via transceiver 516, from a wireless network (e.g., wireless network 130) via apparatus 520 a dynamic signaling. Additionally, processor 512 may activate or deactivate, according to the dynamic signaling, one or more grant configurations associated with one or more configured grants of a plurality of configured grants related to transmissions or receptions with respect to apparatus 510.

Moreover, processor 512 may configure one or more activation or deactivations states. In such cases, each of the one or more states may correspond to a single grant configuration or a set of multiple grant configurations of the one or more grant configurations. In some implementations, each of the one or more grant configurations may be associated with a unique configuration identifier or index. Moreover, each of the one or more activation or deactivation states may be mapped to the respective configuration identifier or index of the single grant configuration or the set of multiple grant configurations of the one or more grant configurations.

Alternatively, processor 512 may configure one or more activation state lists or one or more deactivation state lists. In such cases, each entry in the one or more activation state lists or the one or more deactivation state lists may correspond to a single grant configuration state or a set of multiple grant configuration states of activation or deactivation. In some implementations, each entry in the one or more activation state lists or the one or more deactivation state lists may be associated with a unique state identifier or index. Additionally, each of the one or more grant configurations is mapped to one or more of state identifiers or indices in the one or more activation state lists or the one or more deactivation state lists. In some implementations, in activating or deactivating the one or more grant configurations, processor 512 may map a value in an indicator field in the dynamic signaling and an activation state or a deactivation state of a single configuration grant or each of multiple configuration grants of the plurality of configured grants according to the one or more activation state lists or the one or more deactivation state lists.

In some implementations, in receiving the dynamic signaling, processor 512 may receive a single DCI signaling.

In some implementations, a state identification index associated with the one or more configured grants may be indicated in a dedicated field or an existing field in the dynamic signaling. In such cases, the state identification index associated with the one or more configured grants may be indicated in a field used for a HARQ process ID in the dynamic signaling.

In some implementations, the one or more configured grants may include one or more UL semi-static configured grants, one or more DL semi-static SPS configured grants, or one or more SL semi-static SPS configured grants.

In some implementations, the dynamic signaling may indicate a state identifier. In such cases, in deactivating the one or more grant configurations, processor 512 may perform certain operations. For instance, processor 512 may release one or more downlink semi-persistent scheduling (DL-SPS) configurations associated with the indicated state identifier. Moreover, processor 512 may stop to monitor one or more DL resources associated with the released one or more DL-SPS configurations.

In some implementations, the dynamic signaling may indicate a state identifier. In such cases, in deactivating the one or more grant configurations, processor 512 may perform certain operations. For instance, processor 512 may release one or more uplink configured-grant (UL-CG) configurations associated with the indicated state identifier. Moreover, processor 512 may stop to perform grant-free UL transmissions on one or more UL resources associated with the released one or more UL-CG configurations.

In some implementations, the dynamic signaling may indicate a state identifier. In such cases, in deactivating the one or more grant configurations, processor 512 may perform certain operations. For instance, processor 512 may release one or more sidelink configured-grant (SL-CG) configurations associated with the indicated state identifier. Furthermore, processor 512 may stop to perform grant-free SL transmissions on one or more SL resources associated with the released one or more SL-CG configurations.

In another aspect of semi-static grant activation and deactivation by a single DCI transmission in mobile communications in accordance with the present disclosure, processor 512 of apparatus 510 may receive, via transceiver 516, from a wireless network (e.g., wireless network 130) via apparatus 520 a dynamic signaling. Additionally, processor 512 may activate or deactivate, according to the dynamic signaling, a plurality of grant configurations associated with a plurality of configured grants related to transmissions or receptions with respect to apparatus 510.

Moreover, processor 512 may configure one or more activation states or one or more deactivation states. In such cases, each of the one or more activation states or the one or more deactivation states may correspond to a single grant configuration or a set of multiple grant configurations of the plurality of grant configurations. Additionally, each of the plurality of grant configurations may be associated with a unique configuration identifier or index. Moreover, each of the one or more activation states or the one or more deactivation states may be mapped to the respective configuration identifier or index of the single grant configuration or the set of multiple grant configurations of the plurality of grant configurations.

Alternatively, processor 512 may configure one or more activation state lists or one or more deactivation state lists. In such cases, each entry in the one or more activation state lists or the one or more deactivation state lists may correspond to a single grant configuration state or a set of multiple grant configuration states of activation or deactivation. Moreover, each entry in the one or more configuration state lists may be associated with a unique state identifier or index. Furthermore, each of the plurality of grant configurations may be mapped to one or more of state identifiers or indices in the one or more activation state lists or the one or more deactivation state lists. In some implementations, in activating or deactivating of the plurality of grant configurations, processor 512 may map a value in an indicator field in the dynamic signaling and an activation state or a deactivation state of a single configuration grant or each of multiple configuration grants of the plurality of configured grants according to the one or more activation state lists or the one or more deactivation state lists.

In some implementations, in receiving the dynamic signaling, processor 512 may receive a single DCI signaling. In such cases, a state identification index associated with the one or more configured grants may be indicated in a dedicated field or an existing field in the dynamic signaling. Moreover, the state identification index associated with the one or more configured grants may be indicated in a field used for a HARQ process ID in the dynamic signaling.

In some implementations, the one or more configured grants may include one or more UL semi-static configured grants, one or more DL semi-static SPS configured grants, or one or more SL semi-static SPS configured grants.

In some implementations, the dynamic signaling may indicate a state identifier. In such cases, in deactivating the plurality of grant configurations, processor 512 may perform one or more of a first procedure, a second procedure and a third procedure. The first procedure may involve processor 512 performing the following: (a) releasing one or more DL-SPS configurations associated with the indicated state identifier; and (b) stopping to monitor one or more DL resources associated with the released one or more DL-SPS configurations. The second procedure may involve processor 512 performing the following: (a) releasing one or more UL-CG configurations associated with the indicated state identifier; and (b) stopping to perform grant-free UL transmissions on one or more UL resources associated with the released one or more UL-CG configurations. The third procedure may involve processor 512 performing the following: (a) releasing one or more SL-CG configurations associated with the indicated state identifier; and (b) stopping to perform grant-free SL transmissions on one or more SL resources associated with the released one or more SL-CG configurations.

### Illustrative Processes

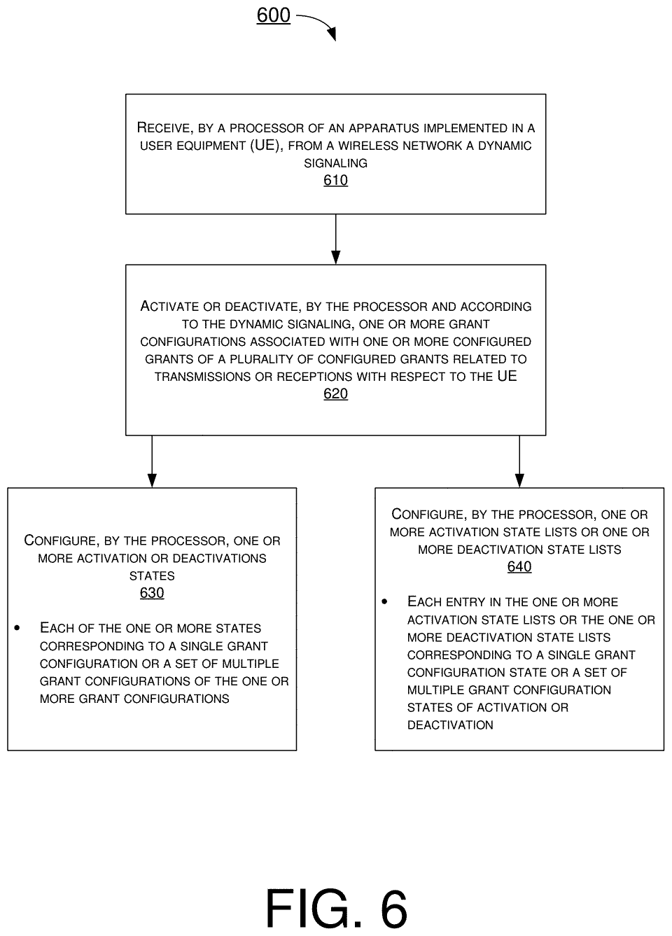

FIG. 6 illustrates an example process 600 in accordance with an implementation of the present disclosure. Process 600 may be an example implementation of the proposed schemes described above with respect to semi-static grant activation and deactivation by a single DCI transmission in mobile communications in accordance with the present disclosure. Process 600 may represent an aspect of implementation of features of apparatus 510 and apparatus 520. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 510, apparatus 520 and/or any suitable wireless communication device, UE, RSU, base station or machine type devices. Solely for illustrative purposes and without limitation, process 600 is described below in the context of apparatus 510 as a UE (e.g., UE 110) and apparatus 520 as a base station (e.g., base station or network 135) in an NR mobile communication environment (e.g., network environment 100). Process 600 may begin at block 610.

At 610, process 600 may involve processor 512 of apparatus 510 (e.g., implemented in UE 110) receiving, via transceiver 516, from a wireless network (e.g., wireless network 130) via apparatus 520 a dynamic signaling. Process 600 may proceed from 610 to 620.

At 620, process 600 may involve processor 512 activating or deactivating, according to the dynamic signaling, one or more grant configurations associated with one or more configured grants of a plurality of configured grants related to transmissions or receptions with respect to apparatus 510. Process 600 may proceed from 620 to 630 or 640.

At 630, process 600 may involve processor 512 configuring one or more activation or deactivations states. In such cases, each of the one or more states may correspond to a single grant configuration or a set of multiple grant configurations of the one or more grant configurations. In some implementations, each of the one or more grant configurations may be associated with a unique configuration identifier or index. Moreover, each of the one or more activation or deactivation states may be mapped to the respective configuration identifier or index of the single grant configuration or the set of multiple grant configurations of the one or more grant configurations.

At 640, process 600 may involve processor 512 configuring one or more activation state lists or one or more deactivation state lists. In such cases, each entry in the one or more activation state lists or the one or more deactivation state lists may correspond to a single grant configuration state or a set of multiple grant configuration states of activation or deactivation. In some implementations, each entry in the one or more activation state lists or the one or more deactivation state lists may be associated with a unique state identifier or index. Additionally, each of the one or more grant configurations is mapped to one or more of state identifiers or indices in the one or more activation state lists or the one or more deactivation state lists. In some implementations, in activating or deactivating the one or more grant configurations, process 600 may involve processor 512 mapping a value in an indicator field in the dynamic signaling and an activation state or a deactivation state of a single configuration grant or each of multiple configuration grants of the plurality of configured grants according to the one or more activation state lists or the one or more deactivation state lists.

In some implementations, in receiving the dynamic signaling, process 600 may involve processor 512 receiving a single DCI signaling.

In some implementations, a state identification index associated with the one or more configured grants may be indicated in a dedicated field or an existing field in the dynamic signaling. In such cases, the state identification index associated with the one or more configured grants may be indicated in a field used for a HARQ process ID in the dynamic signaling.

In some implementations, the one or more configured grants may include one or more UL semi-static configured grants, one or more DL semi-static SPS configured grants, or one or more SL semi-static SPS configured grants.

In some implementations, the dynamic signaling may indicate a state identifier. In such cases, in deactivating the one or more grant configurations, process 600 may involve processor 512 performing certain operations. For instance, process 600 may involve processor 512 releasing one or more downlink semi-persistent scheduling (DL-SPS) configurations associated with the indicated state identifier. Moreover, process 600 may involve processor 512 stopping to monitor one or more DL resources associated with the released one or more DL-SPS configurations.

In some implementations, the dynamic signaling may indicate a state identifier. In such cases, in deactivating the one or more grant configurations, process 600 may involve processor 512 performing certain operations. For instance, process 600 may involve processor 512 releasing one or more uplink configured-grant (UL-CG) configurations associated with the indicated state identifier. Moreover, process 600 may involve processor 512 stopping to perform grant-free UL transmissions on one or more UL resources associated with the released one or more UL-CG configurations.

In some implementations, the dynamic signaling may indicate a state identifier. In such cases, in deactivating the one or more grant configurations, process 600 may involve processor 512 performing certain operations. For instance, process 600 may involve processor 512 releasing one or more sidelink configured-grant (SL-CG) configurations associated with the indicated state identifier. Furthermore, process 600 may involve processor 512 stopping to perform grant-free SL transmissions on one or more SL resources associated with the released one or more SL-CG configurations.

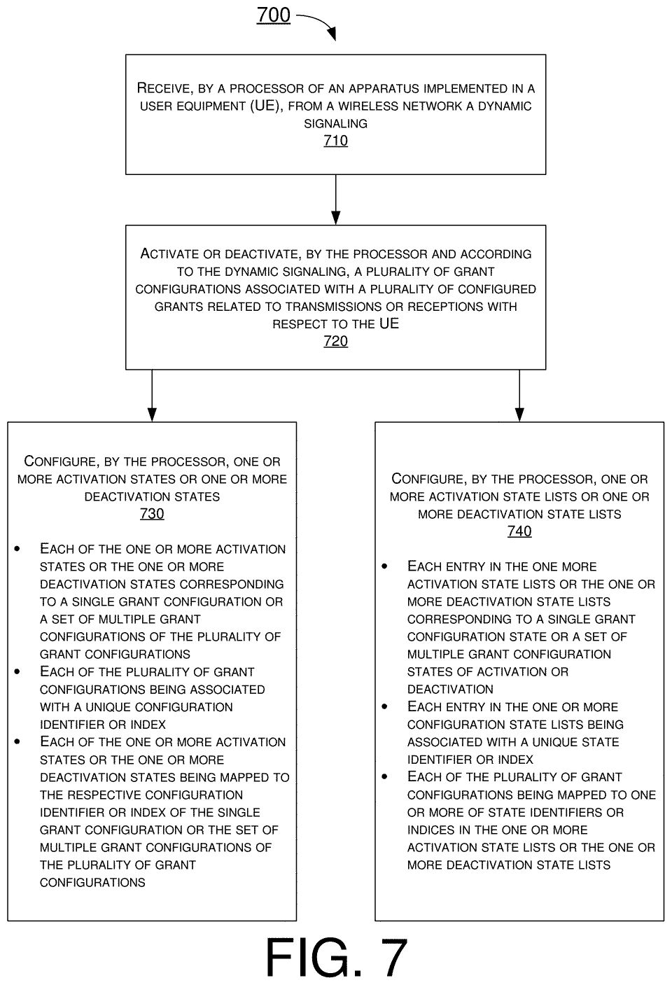

FIG. 7 illustrates an example process 700 in accordance with an implementation of the present disclosure. Process 700 may be an example implementation of the proposed schemes described above with respect to semi-static grant activation and deactivation by a single DCI transmission in mobile communications in accordance with the present disclosure. Process 700 may represent an aspect of implementation of features of apparatus 510 and apparatus 520. Process 700 may include one or more operations, actions, or functions as illustrated by one or more of blocks 710, 720, 730 and 740. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may also be repeated partially or entirely. Process 700 may be implemented by apparatus 510, apparatus 520 and/or any suitable wireless communication device, UE, RSU, base station or machine type devices. Solely for illustrative purposes and without limitation, process 700 is described below in the context of apparatus 510 as a UE (e.g., UE 110) and apparatus 520 as a base station (e.g., base station or network 135) in an NR mobile communication environment (e.g., network environment 100). Process 700 may begin at block 710.

At 710, process 700 may involve processor 512 of apparatus 510 (e.g., implemented in UE 110) receiving, via transceiver 516, from a wireless network (e.g., wireless network 130) via apparatus 520 a dynamic signaling. Process 700 may proceed from 710 to 720.

At 720, process 700 may involve processor 512 activating or deactivating, according to the dynamic signaling, a plurality of grant configurations associated with a plurality of configured grants related to transmissions or receptions with respect to apparatus 510. Process 700 may proceed from 720 to 730 or 740.

At 730, process 700 may involve processor 512 configuring one or more activation states or one or more deactivation states. In such cases, each of the one or more activation states or the one or more deactivation states may correspond to a single grant configuration or a set of multiple grant configurations of the plurality of grant configurations. Additionally, each of the plurality of grant configurations may be associated with a unique configuration identifier or index. Moreover, each of the one or more activation states or the one or more deactivation states may be mapped to the respective configuration identifier or index of the single grant configuration or the set of multiple grant configurations of the plurality of grant configurations.

At 740, process 700 may involve processor 512 configuring one or more activation state lists or one or more deactivation state lists. In such cases, each entry in the one or more activation state lists or the one or more deactivation state lists may correspond to a single grant configuration state or a set of multiple grant configuration states of activation or deactivation. Moreover, each entry in the one or more configuration state lists may be associated with a unique state identifier or index. Furthermore, each of the plurality of grant configurations may be mapped to one or more of state identifiers or indices in the one or more activation state lists or the one or more deactivation state lists. In some implementations, in activating or deactivating of the plurality of grant configurations, process 700 may involve processor 512 mapping a value in an indicator field in the dynamic signaling and an activation state or a deactivation state of a single configuration grant or each of multiple configuration grants of the plurality of configured grants according to the one or more activation state lists or the one or more deactivation state lists.

In some implementations, in receiving the dynamic signaling, process 700 may involve processor 512 receiving a single DCI signaling. In such cases, a state identification index associated with the one or more configured grants may be indicated in a dedicated field or an existing field in the dynamic signaling. Moreover, the state identification index associated with the one or more configured grants may be indicated in a field used for a HARQ process ID in the dynamic signaling.

In some implementations, the one or more configured grants may include one or more UL semi-static configured grants, one or more DL semi-static SPS configured grants, or one or more SL semi-static SPS configured grants.

In some implementations, the dynamic signaling may indicate a state identifier. In such cases, in deactivating the plurality of grant configurations, process 700 may involve processor 512 performing one or more of a first procedure, a second procedure and a third procedure. The first procedure may involve processor 512 performing the following: (a) releasing one or more DL-SPS configurations associated with the indicated state identifier; and (b) stopping to monitor one or more DL resources associated with the released one or more DL-SPS configurations. The second procedure may involve processor 512 performing the following: (a) releasing one or more UL-CG configurations associated with the indicated state identifier; and (b) stopping to perform grant-free UL transmissions on one or more UL resources associated with the released one or more UL-CG configurations. The third procedure may involve processor 512 performing the following: (a) releasing one or more SL-CG configurations associated with the indicated state identifier; and (b) stopping to perform grant-free SL transmissions on one or more SL resources associated with the released one or more SL-CG configurations.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, from a wireless network a dynamic signaling; and
activating or deactivating, by the processor and according to the dynamic signaling, one or more grant configurations associated with one or more configured grants of a plurality of configured grants related to transmissions or receptions with respect to the apparatus.

2. The method of claim 1, wherein the receiving of the dynamic signaling comprises receiving a single downlink control information (DCI) signaling.

3. The method of claim 1, wherein a state identification index associated with the one or more configured grants is indicated in a dedicated field or an existing field in the dynamic signaling.

4. The method of claim 3, wherein the state identification index associated with the one or more configured grants is indicated in a field used for a hybrid automatic repeat request (HARQ) process identification (ID) in the dynamic signaling.

5. The method of claim 1, wherein the one or more configured grants comprise one or more uplink (UL) semi-static configured grants, one or more downlink (DL) semi-static semi-persistent scheduling (SPS) configured grants, or one or more sidelink (SL) semi-static SPS configured grants.

6. The method of claim 1, further comprising:
configuring, by the processor, one or more activation or deactivations states,
wherein each of the one or more states corresponds to a single grant configuration or a set of multiple grant configurations of the one or more grant configurations.

7. The method of claim 6, wherein each of the one or more grant configurations is associated with a unique configuration identifier or index, and wherein each of the one or more activation or deactivation states is mapped to the respective configuration identifier or index of the single grant configuration or the set of multiple grant configurations of the one or more grant configurations.

8. The method of claim 1, further comprising:
configuring, by the processor, one or more activation state lists or one or more deactivation state lists,
wherein each entry in the one or more activation state lists or the one or more deactivation state lists corresponds to a single grant configuration state or a set of multiple grant configuration states of activation or deactivation.

9. The method of claim 8, wherein each entry in the one or more activation state lists or the one or more deactivation state lists is associated with a unique state identifier or index, and wherein each of the one or more grant configurations is mapped to one or more of state identifiers or indices in the one or more activation state lists or the one or more deactivation state lists.

10. The method of claim 8, wherein the activating or deactivating of the one or more grant configurations comprises mapping a value in an indicator field in the dynamic signaling and an activation state or a deactivation state of a single configuration grant or each of multiple configuration grants of the plurality of configured grants according to the one or more activation state lists or the one or more deactivation state lists.

11. The method of claim 1, wherein the dynamic signaling indicates a state identifier, and wherein the deactivating of the one or more grant configurations comprises:
releasing one or more downlink semi-persistent scheduling (DL-SPS) configurations associated with the indicated state identifier; and
stopping to monitor one or more downlink (DL) resources associated with the released one or more DL-SPS configurations.

12. The method of claim 1, wherein the dynamic signaling indicates a state identifier, and wherein the deactivating of the one or more grant configurations comprises:
releasing one or more uplink configured-grant (UL-CG) configurations associated with the indicated state identifier; and
stopping to perform grant-free uplink (UL) transmissions on one or more UL resources associated with the released one or more UL-CG configurations.

13. The method of claim 1, wherein the dynamic signaling indicates a state identifier, and wherein the deactivating of the one or more grant configurations comprises:
releasing one or more sidelink configured-grant (SL-CG) configurations associated with the indicated state identifier; and
stopping to perform grant-free sidelink (SL) transmissions on one or more SL resources associated with the released one or more SL-CG configurations.

14. An apparatus, comprising:
a transceiver configured to communication with a wireless network; and
a processor coupled to the transceiver and configured to perform operations comprising:
receiving, via the transceiver, from a wireless network a dynamic signaling; and
activating or deactivating, according to the dynamic signaling, a plurality of grant configurations associated with a plurality of configured grants related to transmissions or receptions with respect to the apparatus.

15. The apparatus of claim 14, wherein, in receiving the dynamic signaling, the processor receives a single downlink control information (DCI) signaling, wherein a state identification index associated with the one or more configured grants is indicated in a dedicated field or an existing field in the dynamic signaling, and wherein the state identification index associated with the one or more configured grants is indicated in a field used for a hybrid automatic repeat request (HARQ) process identification (ID) in the dynamic signaling.

16. The apparatus of claim 14, wherein the one or more configured grants comprise one or more uplink (UL) semi-static configured grants, one or more downlink (DL) semi-static semi-persistent scheduling (SPS) configured grants, or one or more sidelink (SL) semi-static SPS configured grants.

17. The apparatus of claim 14, the processor is further configured to perform operations comprising:
configuring one or more activation states or one or more deactivation states,
wherein each of the one or more activation states or the one or more deactivation states corresponds to a single grant configuration or a set of multiple grant configurations of the plurality of grant configurations,
wherein each of the plurality of grant configurations is associated with a unique configuration identifier or index, and
wherein each of the one or more activation states or the one or more deactivation states is mapped to the respective configuration identifier or index of the single grant configuration or the set of multiple grant configurations of the plurality of grant configurations.

18. The apparatus of claim 14, the processor is further configured to perform operations comprising:
configuring one or more activation state lists or one or more deactivation state lists,
wherein each entry in the one or more activation state lists or the one or more deactivation state lists corresponds to a single grant configuration state or a set of multiple grant configuration states of activation or deactivation,
wherein each entry in the one or more configuration state lists is associated with a unique state identifier or index, and
wherein each of the plurality of grant configurations is mapped to one or more of state identifiers or indices in the one or more activation state lists or the one or more deactivation state lists.

19. The apparatus of claim 18, wherein, in activating or deactivating the plurality of grant configurations, the processor maps a value in an indicator field in the dynamic signaling and an activation state or a deactivation state of a single configuration grant or each of multiple configuration grants of the plurality of configured grants according to the one or more activation state lists or the one or more deactivation state lists.

20. The apparatus of claim 14, wherein the dynamic signaling indicates a state identifier, and wherein, in deactivating the plurality of grant configurations, the processor performs one or more of a first procedure, a second procedure and a third procedure, and wherein:
the first procedure comprises:
releasing one or more downlink semi-persistent scheduling (DL-SPS) configurations associated with the indicated state identifier; and
stopping to monitor one or more downlink (DL) resources associated with the released one or more DL-SPS configurations, the second procedure comprises:
releasing one or more uplink configured-grant (UL-CG) configurations associated with the indicated state identifier; and
stopping to perform grant-free uplink (UL) transmissions on one or more UL resources associated with the released one or more UL-CG configurations, and
the third procedure comprises:
releasing one or more sidelink configured-grant (SL-CG) configurations associated with the indicated state identifier; and
stopping to perform grant-free sidelink (SL) transmissions on one or more SL resources associated with the released one or more SL-CG configurations.
